(19) United States
(12) Patent Application Publication
(10) Pub. No.: US 2023/0351461 A1
(43) Pub. Date: Nov. 2, 2023

(54) VERIFIED PURCHASING NETWORK

(71) Applicant: PWCC Marketplace, LLC, Tigard, OR (US)

(72) Inventor: Brent Huigens, Portland, OR (US)

(21) Appl. No.: 18/142,507

(22) Filed: May 2, 2023

Related U.S. Application Data
(60) Provisional application No. 63/337,513, filed on May 2, 2022.

(51) Int. Cl. G06Q 30/0601

(52) U.S. Cl. CPC G06Q 30/0609; G06Q 30/0613

(57) ABSTRACT

A secure network for uniquely identified objects includes a receiver for accepting electronic data about one or more uniquely identified items, a verification processor for physically receiving one or more uniquely identified items from a source external to the secure network, and for comparing identifying information physically attached to the one or more uniquely identified items to the electronic data received from the one or more uniquely identified items, a database for storing the electronic data about the one or more uniquely identified items as well as information generated within the secure network, and a marketplace to offer the one or more uniquely identified items for sale. Methods are also described.

### CROSS-REFERENCE TO RELATED APPLICATIONS

This application claims benefit of U.S. Provisional Application 63/337,513, entitled VERIFIED PURCHASING NETWORK, filed May 2, 2022, the disclosure of which is incorporated herein by reference.

### FIELD OF THE INVENTION

This disclosure is related to identifying objects, and, more particularly, to a system for generating unique identifiers of objects using multi-media.

### BACKGROUND

Physical objects are by definition unique, meaning there are no two that are exactly alike. Some objects that are seemingly identical may include unique identifiers. For instance, two otherwise identical watches may be marked with different serial numbers, allowing the watches to be easily distinguished.

Most objects have no unique identifier, however, making it very difficult to tell one object from another. Trading cards are examples of objects having no unique identifier. For these reasons, two otherwise identical cards may be very difficult to distinguish and may require an expert in card identification to do so.

The resale market for trading cards is very robust, which also means that the market is ripe for fakes, or non-genuine goods, entering the market. Using an expert to identify that a particular card is genuine adds a layer of expense and complexity, and it may be appropriate for cards having significant value. Most cards in the trading card market will not have their genuineness verified by an expert, though, and therefore there is always a risk in a transaction that a particular card has been substituted or faked.

Embodiments according to this disclosure address these and other shortcomings of conventional card and item tracking.

### BRIEF DESCRIPTION OF THE DRAWINGS

FIG. 1 is a block diagram illustrating how items are originated and verified before being passed to a secure network, according to embodiments of the invention.

FIG. 2 is a sample database of information to be stored about a unique object, according to embodiments of the invention.

FIG. 3 is a flowchart of a process of generating a unique identifier for objects using multi-media, according to embodiments of the invention.

FIG. 4 is a functional block system diagram illustrating an operational network on which embodiments of the invention may operate.

FIG. 5. is a block diagram illustrating items being accepted into a secure network and various operations that take place within the secured network, according to embodiments of the invention.

### DESCRIPTION

Embodiments of the invention are directed to generating unique identifiers of objects using multi-media and other systems. A non-limiting example is described in this disclosure, but embodiments of the invention are not limited to the examples provided below.

A card breaker, or “breaker,” is a person who opens a sealed package or many sealed packages of trading cards and extracts the individual cards. Generally, the breaker purchases the sealed packages directly from the manufacturer or from a third party. Breakers may purchase the sealed packages at a discount from retail prices and pre-sell a particular one of the cards, or groups of cards, to a retail purchaser. For example, a breaker may purchase 20 packs of cards and pre-sell the cards contained within the packs to four buyers, with each buyer pre-purchasing 5 packs of cards. In another example, a breaker may purchase 20 packs of cards but only pre-sell 10 packs, and offer the other cards for sale after being opened. In many instances, the breaker records or streams a video of the breaker opening the packages, which may build excitement of the purchasers as they watch the breaker unveil the cards. This excitement may extend to others as well, who may view the video stream over social media to watch the unpackaging, even though they themselves are not owners or did not pre-purchase any of the cards. Certain breakers may become personalities or celebrities within the card community. These breakers' videos may be streamed at a collective site, or channel, available over the internet. The breaker videos may also be stored at particular sites, such as YouTube. There may be so much interest in a particular breaker, or breaker channel, that the breaker can sell advertising or otherwise monetize their breaking experience.

Some embodiments of the invention create a unique identifier for cards opened by breakers, as the packages are opened, and individually associate those unique identifiers to the opened cards, effectively making each card a uniquely identified object. Further, the breaker may associate video, audio, or still images of the breaker opening the cards to the unique identifier, which provides a history of the card opening event. In one embodiment, the cards in the packages are provided a unique identifier as soon as the card is removed from the packaging. One embodiment of the invention generates a unique card identifier, which may be a unique bar code, such as a 2-D barcode, to uniquely identify a particular card. Another unique card identifier may be any unique code, or string of codes, such as an alpha-numeric string, and does not necessarily need to be a barcode. Recall from above that the breaker generally records or streams the action of opening the packages of cards on video. After the card has been associated with a unique code, the portion of the breaker video that includes the actual opening of a particular card is also associated with the unique card identifier that is generated for the card. In some embodiments, the breaker inserts the card into a protective pouch, prints a sticker of the unique 2-D barcode image, then seals the pouch with the sticker. In other embodiments the pouch is sealed with a tamper-proof seal, and then the barcoded sticker is applied to the pouch. Tamper-proof seals are physical seals that change appearance when they have been opened. In other words, it is impossible to break or open a tamper-proof seal without evidence that the seal has been broken. As a result, using tamper-proof seals on sealed packages provides strong evidence of whether the package has been previously opened. In the case of cards, using a tamper proof seal provides evidence that the original card placed in the package is the same card when the pouch with the tamper-proof seal is later analyzed. In some embodiments the 2-D barcode image is printed on or is integrated with the tamper-proof seal itself. Although this description of embodiments is generally focused on opening and uniquely identifying cards, embodiments are applicable to any physical object.

Performing these operations is one way to create a unique identifier of an object using multi-media. In this example, the multi-media includes the video of the breaker opening the card from its package, which may be referred to as the “birthday” of the card. Of course, not all these details are required for all embodiments.

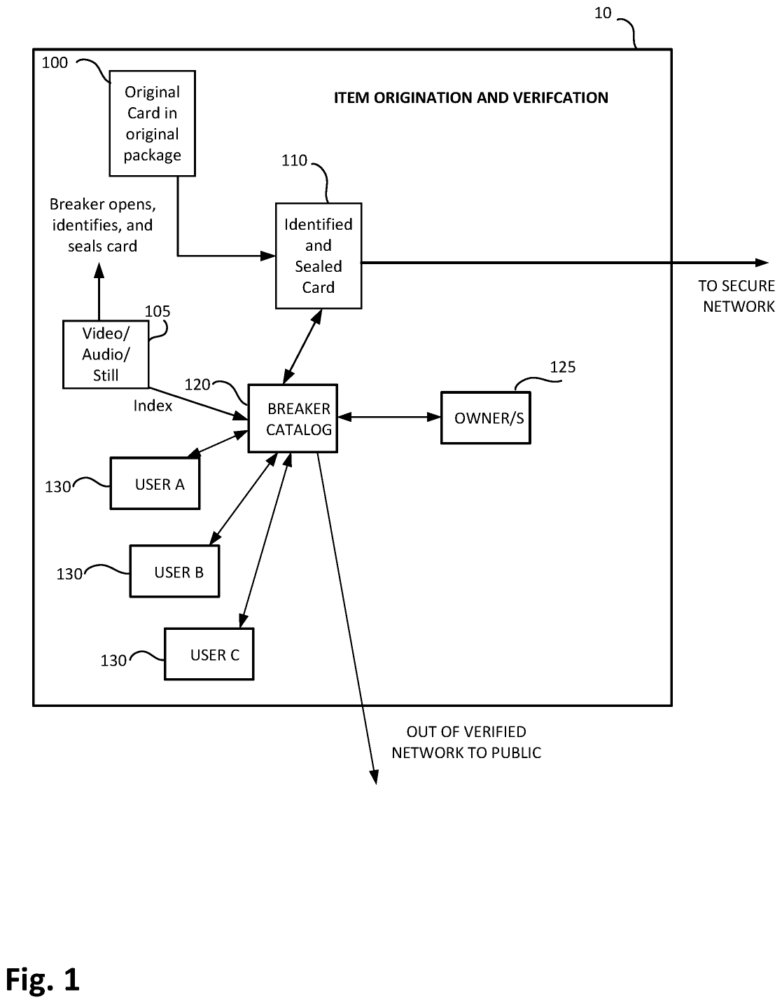

FIG. 1 is a block diagram depicting an environment 10 in which this process of creating unique identifiers for verifying the origination of cards or other objects in a resale market may occur. As shown in FIG. 1, in embodiments of the disclosure, a card 100 begins in its original, unopened package, the contents of which are unknown. The original package is opened by a breaker and the card or cards revealed. As described above, the opening of the card from its package may be recorded or streamed, such as by video 105. In other embodiments audio recordings or still photos of the opening process may be generated. After opening, the card is presented with a unique identifier, such as a barcode, and sealed in a pouch that is identified with the unique identifier and becomes identified card 110.

This uniquely identified card 110 may be stored in a breaker catalog 120, which is a list or database of the cards associated with the breaker.

The breaker may then share or publish the breaker's catalog 120 with an owner 125 who has pre-purchased a card or group of cards in the catalog or to a variety of users 130, who may have viewed the breakers' video stream. The breaker's catalog 120 may also be shared publicly.

Other information about the card, or item, may be added to a record, for example in a database, which is also associated with the unique card identifier. Such information may include the date, time, and location that the package was opened and the card extracted. If the breaker was recording the action of opening the card through a mobile phone, the date, time, and location may be extracted automatically from the phone. Other information stored in the record may include the name and/or identification of the breaker who opened the card. Further, the breaker may take still images of the card, such as through the phone, or through other means, which can also be saved in association with the unique record of the card. Other multi-media that may be associated with the unique card identifier includes an audio file with a recording of anything the breaker may have stated when opening the card. An audio file could also include a recording of a third party, such as an expert, opining on the value, uniqueness, or other quality of the card, or this expert information may be merely stored in character form along with the other information.

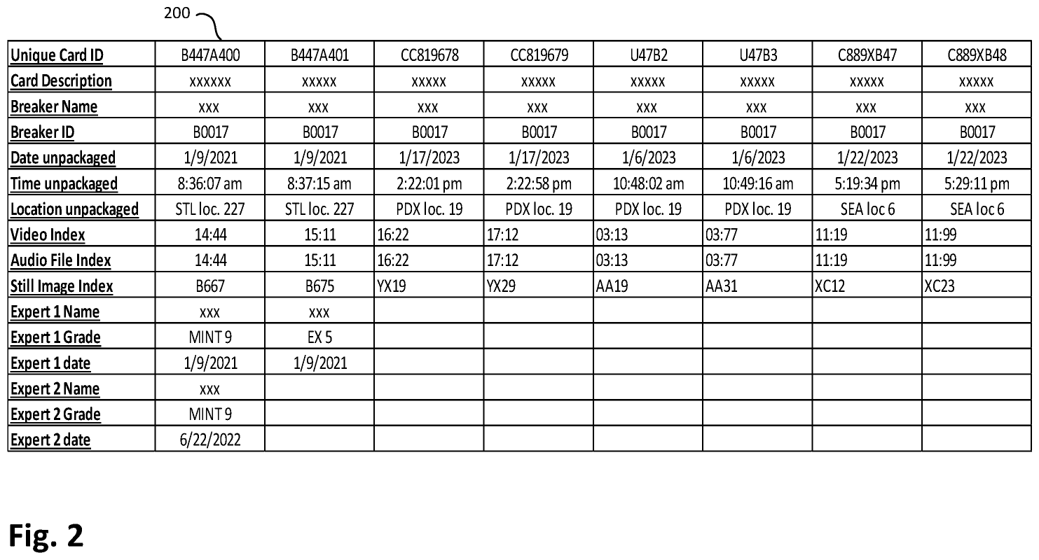

A sample database 200 for storing information about an item is depicted in FIG. 2. As shown, this sample database 200 includes the item's unique identifier, a description of the item, the identity of the breaker who unpackaged the item, and the date, time, and location the item was unpackaged. However, as discussed above, databases in other embodiments of the disclosure may include more or less information about the item. Also, the sample database 200 of FIG. 2 may be an example of the breaker catalog 120, a supplemental database indexed to the breaker catalog 120 that provides additional information about the uniquely identified cards, or a standalone database for use by a provider of card information, such as a card marketplace operator. Further, although the database 200 is presented as a flat database, any type of database may be used so long as the data stored therein is associated with the unique identifier.

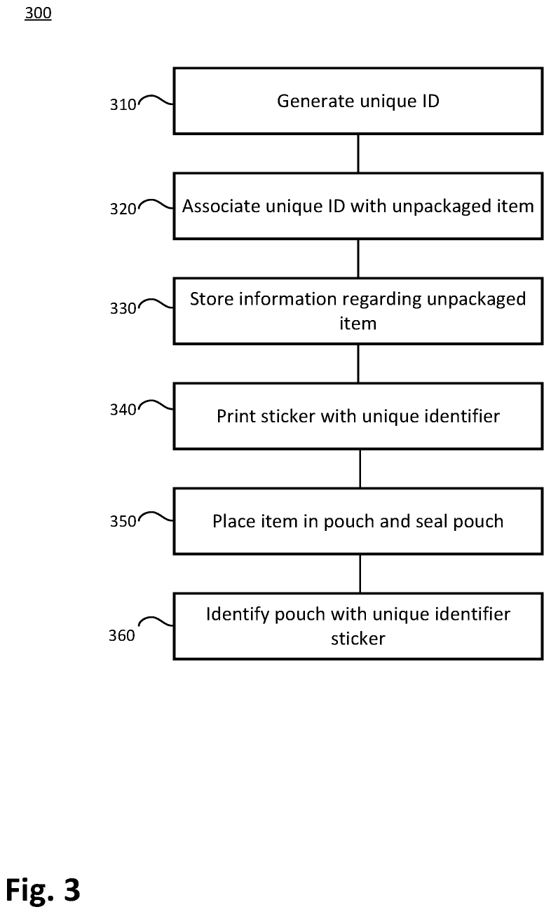

A flowchart 300 illustrating example operations that may be used in embodiments of the disclosure is depicted in FIG. 3. As shown, a breaker unpacking cards and performing the operations for uniquely identifying each card may first generate a unique identifier at operation 310. For example, the breaker may initiate an operation on a computer, described below, that generates the unique identifier. The unique identifiers may be serially assigned, randomly assigned, or assigned through other processes. In an operation 320, the breaker, or other party, associates the unique identifier generated in operation 310 to a card, or other item being identified. The breaker may then store information about the item at operation 330, storing information such as the breaker's identity, a description of the card, and the date, time, and location the card was unpackaged. Some of this data may be automatically populated in a database, such as obtaining a time and location stamp for a particular breaking action from a phone, computer, or other device present at the breaking. Other data may additionally be populated about the uniquely identified item, such as that described above, or other information that a card collector may find valuable or useful. Next, the breaker may print a sticker with the unique identifier, or use other means of associating the unique identifier with the opened item at an operation 340. Then, the breaker, or another party seals the card or item in a pouch and secures the pouch in an operation 360. As described above, the pouch may be sealed with a tamper-proof seal, or other methods used for sealing the pouch. The sticker printed in operation 340 may then be adhered to the pouch to identify the contents of the pouch with the unique identifier in an operation 360. In some embodiments, the operations 350 and 360 may be combined by sealing the pouch with the unique identifier sticker. Once this process is complete, the pouch containing the uniquely identified item may be moved to a secure location, such as a vault, to provide additional security that the pouch has not been tampered with. In other embodiments, the pouch containing the uniquely identified item may be physically transferred to the owner 125 (FIG. 1), or to someone who purchased the item, such as a user 130. In yet other embodiments, the pouch or pouches of individually identified items may remain with the breaker while they are offered for sale.

Breakers may perform the above-described operations on a computer device, such as a mobile phone, computer server, or other device. In any event, the breaker may run software provided by the owner or operator of a secure network, so that the items being ingested into the secure network adhere to a common framework. That is, each item cataloged through the software will have the same basic format, such as photos, video streams, identification data, etc.

Some of the above process may be automated. In some embodiments, a process may be performed on the video of the card, or subsequent images associated with the card, that identifies the manufacturer of the card as well as the contents of the card itself, such as the player and team identification. Embodiments may use machine learning to train the system to reliably identify cards. In other embodiments, some or all the information about the card may be entered manually, or through voice-recognition software, such as manufacturer, card series, sport, league, team, player, year, status (such as rookie), etc. Some of this data may be pre-populated or duplicated to all the cards in the box, if known, such as manufacturer and year. Metadata may also be stored, such as identification of the box containing the original wax packages, the wax package itself, or other data. If the particular card has been pre-purchased by a user, owner details may be entered and associated with the card as well, including whether or not the owner is interested in selling the card. These details are kept as a database or in spreadsheet form, all of which are indexed to the specific card.

In other embodiments, the records of all the cards, including the unique identifiers and associated multi-media files, are assembled into a catalog of cards, which may be presented to the public, or certain private members, for sale.

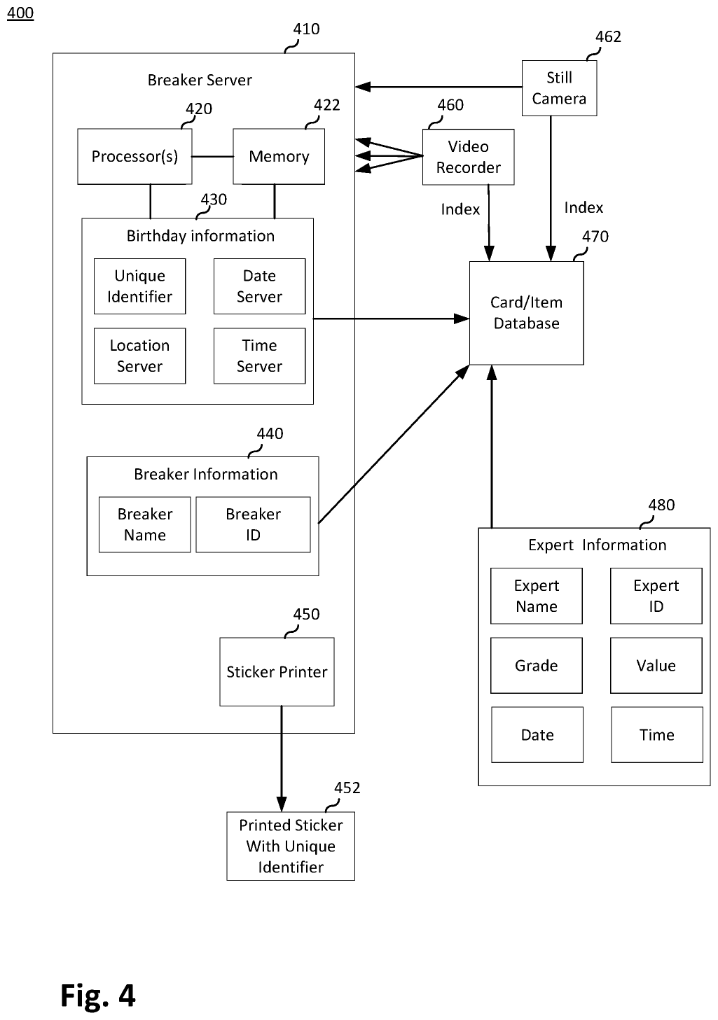

FIG. 4 is a functional block diagram illustrating an operational network 400 on which embodiments of the invention may operate. The operational network 400 generally includes a breaker server 410, a video recorder 460, a still camera 462, which may be integrated into a portable phone, and a card/item database 470, on which identification and other information about an item or card may be stored. In some cases, one or more experts may provide value or grade information 480 about the card, which may be assembled with the other information and input to the card/item database 470 or stored in an audio file associated with the database. Alternatively, or in addition, information such as value, identity, and grade, for example, may be generated from non-human sources, such as a system or automated means. The card/item database may include further information described above and/or with reference to FIG. 2. Not all components of the illustrated operational network 400 are required in all embodiments of the invention. Also, some of the functions separately depicted may be integrated into one or more devices.

The breaker server 410 provides the central functions performed by the breaker, as described above. The breaker server 410 includes one or more processors 420 coupled to a memory 422 in conventional fashion. The memory 422 may include instructions or computer applications to be run on the one or more processors 420. The memory 422 may further include data storage relevant to the functions of the breaker or the breaker network.

Birthday information 430 is provided through functions or operations running on the breaker server 410. In some embodiments this information may be provided by one or more separate devices. Birthday information includes, as described above, a unique identifier to uniquely identify items or cards, as well as date, time, and location servers. In some embodiments, the date, time, and location servers may be operations running on other hardware, such as the video recorder 460, still camera 462, or other device. In operation, the breaker may control the breaker server 410 to generate a unique identifier for each item to be uniquely identified. For instance, the breaker may press a hardware button, or use a mouse or other input to initiate an application or process to generate the unique identifier. All of the birthday information may be sent to the card/item database 470 and indexed to the unique identifier, so that the birthday information may be effectively coupled to the card or item associated with that unique identifier.

Breaker information 440 may include the name and identification of the breaker, which is stored along with the other information indexed to the unique identifier in the card/item database 470.

In some embodiments, an expert may provide additional information about the uniquely identified cards or items stored in the card/item database 470. For example, an expert person or company may provide a grade of the card/item, and perhaps even an opinion of the present value. This information, along with the name, identification, as well as a date, time and perhaps location (not illustrated) that the expert rendered such an opinion may be stored in the card/item database 470 that is indexed to the uniquely identified object.

Further, as described above, the breaker server 410 may include, or be coupled to a sticker printer 450 or other device that prints a physical label of the unique identifier, such as a sticker 452 that may be placed on the item or on an item container, such as a pouch. Then, after the breaker places the item in the pouch, the sticker 452 with the unique identifier may be adhered to or otherwise attached to the pouch, thus uniquely identifying the item stored within.

The video recorder 460 and still camera 462 may take video, audio, and still photos of the item, or the breaker, as it is being opened. Not only does this provide evidence of a physical chain of custody from the time the card is opened until it is placed in the secure pouch, this information may be valuable or enjoyable to the present or future owner of the card. Indices or actual copies of the video recording and still photos may be stored in the card/item database 470 and indexed to the unique identifier. This multi-media collection may have value separate from the uniquely identified item itself, but will likely be most valuable when indexed to the particular card or item that is the subject of the video and/or still photos. Although not specifically described previously, the video information typically also includes audio information recorded coincident with the video and is generally stored as a part of the video file, which is perhaps better described as a video/audio file or snippet.

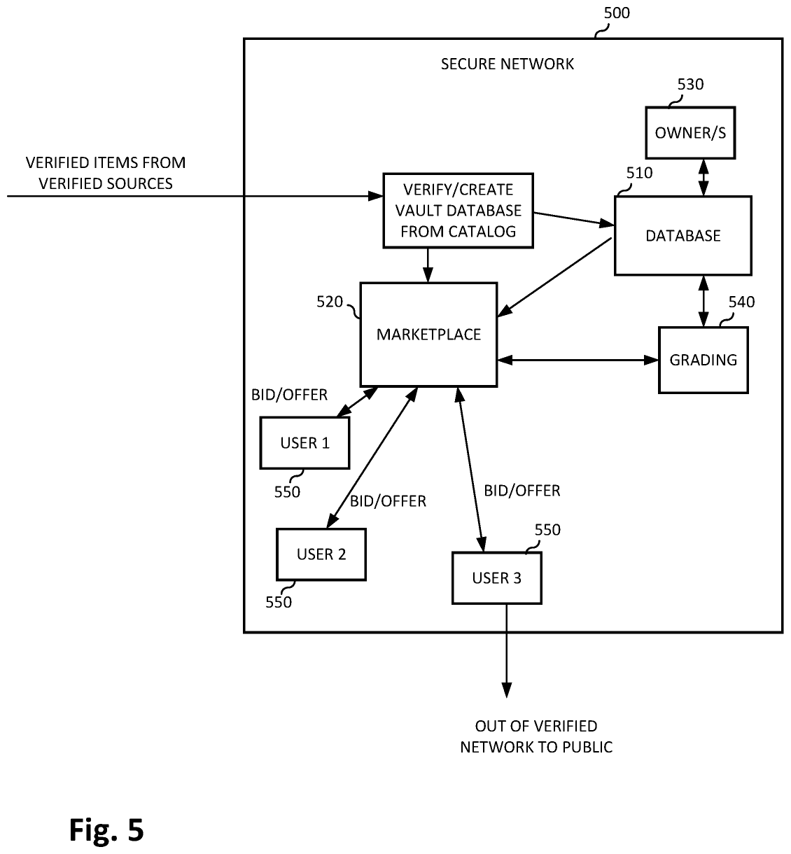

FIG. 5 is a block diagram of a secure network 500 on which methods and operations that the operator of the secure network can readily assemble the items provided by the various sources as described above into a common marketplace. As described above, the secure network is typically owned or operated by a single actor, which ensures that all of the operations within the secure network are secure.

Verified items are received from the Sources as described above. The physical cards or other verified objects may be physically transported to the operator of the secured network in the plastic sleeves, graded packages, or other uniquely identified manner described above. The physical assets may be kept in safe storage, such as a vault that is locked and access is only given to the operator of the secured network, or other authorized agents. Information about the physical items, such as the card information described above may be verified in the secure network 500 as they are received and the information stored in a database 520. The database 520 may include the information described above with reference to FIG. 2, and may include additional information, such as when the item was received, who it was checked in by, and its current location, such as a specific location within the vault. Verifying the information originating from the source may include comparing the barcodes or other identifying features of the physical item against the information previously sent from the Source. Once an item is physically in possession of the secure network and the information record about that item has been verified, it can be placed in a secure marketplace 520, i.e., offered for sale. Items may be offered for direct sale, or may be placed in one or more auctions. Items may be kept in the secure network 500 until the operator deems them ready for sale, at which time they will be placed in the marketplace 510. Recall that the items in the marketplace 510 may be owned by an owner 530, described above, or they may be owned by the secure network operator itself. If owned by an owner 530, the owner may be charged a fee to have the item remain within the secure network. The fee may be periodic, or a la cart based on services provided by the secure network.

If a particular item is sold, the new owner's information may be associated with the record. The new owner may choose to have the item sent out of the network to the new owner, at which time it is removed or marked as sold from the list of items actively marketed in the marketplace. Information in the database 510 is also updated to reflect when each item was sold, and, if it left the secured network 500, the date and time it was removed from the network, as well as who it was released to. A sales fee may be automatically debited from the previous owner's account, or a portion of a buyer's premium, collected by the secure network at the time the item is sold, may be credited to the previous owner's account. Also, a set fee amount or portion of the purchase price may be credited to the original Source of the item being entered into the secure network 500. In this manner breakers are enticed to have the cards they break enter the secure network 500. In some embodiments the breakers may be credited with each subsequent sale of the item, provided it stays within the secure network. The record of the item may be retained indefinitely in the secure network. Also, the new owner may choose to leave the item within the secure network 500 and be offered for sale on the marketplace 520 again at a later time. An item may be sold multiple times all while remaining within the secure network 500. If so, each new owner 530, as well as ancillary data such as data sold, price paid, premium collected, breaker's fee, etc., may be added to the item record in the database 510.

When an owner 530 purchases the item, they may be given a copy of, or access to, the item record or portions of the item record. In this way the owner is given access to the original video of when the item was removed from the original box by the Source. So, the owner can trace back the origin of the card to the very earliest source. And the owner also knows that the verified item has been securely stored by the operator of the secured network 500 the entire time between when the card was opened, verified, sent to the secure network, and sold, even if significant time passes between the original opening date and the sale to the final purchaser who removes it from the verified network. The verification adds authenticity to the item being sold, effectively raising its value. Access to the card or item data may be limited to authorized users, such as users that are registered with the secure network 500.

Ancillary services may be provided by the operator of the secure network 500 or provided by a third party under the control or by agreement with the operator. If services are to be provided by a third party, custodial records are kept and associated with the item in the database 510, as described below. For example, a card may be graded, or have an examination report made, while it is within the secure network 500. In one embodiment, the grader opens the sealed package that has the barcode printed on it, identifying the specific card being graded. Then, after grading, the grader may place the card in a sealed package and attach either another copy, or, preferably, a new identifying barcode to the sealed package. Then the record is updated to reflect the new barcode, which is associated to the proper card record, and will be eventually part of the database 510. When grading, valuation, or other services are performed by third parties, the object to be graded or evaluated is physically transported to the service provider in the original or a subsequent identifiable package. Information about the external services 540 may also be recorded and stored in the card record of the database 510, such as what organization did the grading or valuation, the specific identity of the service provider, the grade and/or value itself, perhaps a grading or value range, and the date and time the evaluation took place, among other data. The grading information 540 may be associated with the uniquely identified item before or after the item enters the secure network 500.

Recall that some owners purchase slots of cards to be opened by the breaker, even before the identity of the card is known. Purchasers may pre-select that the cards they own will be automatically graded, or this may be determined individually by the purchaser/owner. Or a subsequent purchaser may direct that a card may be graded. Or the secure network 500 operator may decide to have certain cards graded.

In some embodiments, some specific card information from the card record is only provided to purchasers of graded cards. For example, purchasers of graded cards may be given access to the original video taken when the card was open, but purchasers of non-graded cards may not be given such access to the video.

In other embodiments, access to particular data stored in the item record about the purchased item may be provided in certain levels, depending on various criteria. A first level, containing basic information, may be provided to any purchaser. If the purchaser is a registered user with the secure network 500, they may be provided access to additional, but perhaps not all information, such as the date and time the item was verified. If the purchaser is a registered user and they purchased a graded card, they may be provided with even more information, such as access to the verifying video. Other information about the item may be provided for a premium fee, such as a listing of all of the purchases of a particular card, as well as the price paid each time the card was sold to a new buyer.

The previously described versions of the disclosed subject matter have many advantages that were either described or would be apparent to a person of ordinary skill. Even so, these advantages or features are not required in all versions of the disclosed apparatus, systems, or methods.

Additionally, this written description makes reference to particular features. It is to be understood that the disclosure in this specification includes all possible combinations of those particular features. Where a particular feature is disclosed in the context of a particular aspect or example, that feature can also be used, to the extent possible, in the context of other aspects and examples.

Also, when reference is made in this application to a method having two or more defined steps or operations, the defined steps or operations can be carried out in any order or simultaneously, unless the context excludes those possibilities.

Although specific examples of the disclosure have been illustrated and described for purposes of illustration, it will be understood that various modifications may be made without departing from the spirit and scope of the disclosure.

1. A secure network for uniquely identified objects, the network comprising:
a receiver for accepting electronic data about one or more uniquely identified items;
a verification processor for physically receiving one or more uniquely identified items from a source external to the secure network, and for comparing identifying information physically attached to the one or more uniquely identified items to the electronic data received from the one or more uniquely identified items;
a database for storing the electronic data about the one or more uniquely identified items as well as information generated within the secure network; and
a marketplace to offer the one or more uniquely identified items for sale.

2. The secure network according to claim 1, in which information generated within the secure network is generated by an operator of the secure network or under the direction of the operator of the secure network.

3. The secure network according to claim 1, in which the secure network includes a physical storage vault for storing the one or more uniquely identified items.

4. The secure network according to claim 1, in which one or more uniquely identified items are stored with a third-party separate from the secure network, and in which the secure network includes storage information from the third-party storage vault.

5. The secure network according to claim 1, in which the one or more uniquely identified items are trading cards.

6. The secure network according to claim 1, in which a unique identifier for an individual trading card is generated during a video session, and in which information about the video session is stored in conjunction with the uniquely identified trading card.

7. The secure network according to claim 1, in which, after the one or more uniquely identified items are sold through the marketplace, the database is updated to reflect information about the sale including the identity of the purchaser, the date sold, and the purchase price.

8. The secure network according to claim 7, in which, after the one or more uniquely identified items are sold through the marketplace, the one or more uniquely identified items remain in control of an operator of the secure network.
